(19) United States
(12) Patent Application Publication
(10) Pub. No.: US 2004/0103105 A1
(43) Pub. Date: May 27, 2004

(54) Subtree-structured XML database

(75) Inventors: Christopher Lindblad, Berkeley, CA (US); Paul Pedersen, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Cerisent Corporation, San Mateo, CA (US)

(21) Appl. No.: 10/462,100

(22) Filed: Jun. 13, 2003

Related U.S. Application Data
(60) Provisional application No. 60/388,717, filed on Jun. 13, 2002.

(51) Int. Cl. G06F 17/00

(52) U.S. Cl. 707/100

(57) ABSTRACT

Structured hierarchical documents containing data, such as XML documents, are input and stored in a structured database such as an XML database. The hierarchical structure of the document is represented as a collection of subtrees in which a subtree can be updated without affecting other subtrees. The relationship between neighboring subtrees is maintained by providing a link node in each subtree that stores a reference to the neighboring subtree. Subtrees can be organized into larger structures to support efficient searching of the structured database.

### CROSS-REFERENCE TO RELATED APPLICATIONS

This application claims the benefit of U.S. Provisional Application No. 60/388,717, filed Jun. 13, 2002, entitled “XML-DB Subtree Storage,” which disclosure is incorporated herein by reference for all purposes. The present disclosure is related to the following commonly assigned co pending U.S. patent applications:

Ser. No. ______ (Attorney Docket No. 021512 000210US, filed on the same date as the present application, entitled “PARENT-CHILD QUERY INDEXING FOR XML DATABASES” (hereinafter “Lindblad II-A”);

Ser. No. ______ (Attorney Docket No. 021512 000310US, filed on the same date as the present application, entitled “XML DB TRANSACTIONAL UPDATE SYSTEM” (hereinafter “Lindblad III-A”); and

Ser. No. ______ (Attorney Docket No. 021512 000410US, filed on the same date as the present application, entitled “XML DATABASE MIXED STRUCTURAL-TEXTUAL CLASSIFICATION SYSTEM” (hereinafter “Lindblad IV-A”); The respective disclosures of these applications are incorporated herein by reference for all purposes.

### BACKGROUND OF THE INVENTION

1. Field of the Invention

This invention relates in general to accessing structured databases and evaluating queries across one or more structured databases and more specifically to accessing XML databases and evaluating queries such as XPath and XQuery queries across one or more structured databases.

2. Description of Related Art

Extensible Markup Language (XML) is a restricted form of SGML, the Standard Generalized Markup Language defined in ISO 8879 and XML is one form of structuring data. XML is more fully described in “Extensible Markup Language (XML) 1.0 (Second Edition)”, W3C Recommendation (6 Oct. 2000), which is incorporated by reference herein for all purposes [and available at http://www.w3.org/TR/2000/REC-xml-20001006] (hereinafter, “XML Recommendation”). XML is a useful form of structuring data because it is an open format that is human-readable and machine-interpretable. Other structured languages without these features or with similar features might be used instead of XML, but XML is currently a popular structured language used to encapsulate (obtain, store, process, etc.) data in a structured manner.

An XML document has two parts: 1) a markup document and 2) a document schema. The markup document and the schema are made up of storage units called “elements”, which can be nested to form a hierarchical structure. An example of an XML markup document 10 is shown in FIG. 1. Document 10 (at least the portions shown) contains data for one “citation” element. The “citation” element has within it a “title” element, and “author” element and an “abstract” element. In turn, the “author” element has within it a “last” element (last name of the author) and a “first” element (first name of the author). Thus, an XML document comprises text organized in freely-structured outline form with tags indicating the beginning and end of each outline element. A tag is delimited with angle brackets surrounding the tag's name, with the opening and closing tags distinguished by having the closing tag beginning with a forward slash after the initial angle bracket.

Elements can contain either parsed or unparsed data. Only parsed data is shown for document 10. Unparsed data is made up of arbitrary character sequences. Parsed data is made up of characters, some of which form character data and some of which form markup. The markup encodes a description of the document's storage layout and logical structure. XML elements can have associated attributes, in the form of name-value pairs, such as the publication date attribute of the “citation” element. The name-value pairs appear within the angle brackets of an XML tag, following the tag name.

XML schemas specify constraints on the structures and types of elements and attribute values in an XML document. The basic schema for XML is the XML Schema, which is described in “XML Schema Part 1: Structures”, W3C Working Draft (24 Sep. 1999), which is incorporated by reference herein for all purposes [and available at http://www.w3.org/TR/1999/WD-xmlschema-1-19990924]. A previous and very widely used schema format is the DTD (Document Type Definition), which is described in the XML Recommendation.

Since XML documents are typically in text format, they can be searched using conventional text search tools. However such tools might ignore the information content provided by the structure of the document, one of the key benefits of XML. Several query languages have been proposed for searching and reformatting XML documents that do consider the XML documents as structured documents. One such language is XQuery, which is described in “XQuery 1.0: An XML Query Language”, W3C Working Draft (20 Dec. 2001), which is incorporated by reference herein for all purposes [and available at http://www.w3.org/TR/XQuery]. An example of a general form for an XQuery query is shown in FIG. 2. Note that the ellipses at line [03] indicate the possible presence of any number of additional namespace prefix to URI mappings, the ellipses at line [12] indicate the possible presence of any number of additional function definitions and the ellipses at line [17] indicate the possible presence of any number of additional FOR or LET clauses.

XQuery is derived from an XML query language called Quilt [described at http://www.almaden.ibm.com/cs/people/chamberlin/quilt.html], which in turn borrowed features from several other languages, including XPath 1.0 [described at http://www.w3.org/TR/XPath.html], XQL [described at Http://www.w3.org/TandS/QL/QL98/pp/xql.html], XML-QL [described at http://www.research.att.com/˜mff/files/final.html] and OQL.

Query languages predated the development of XML and many relational databases use a standardized query language called SQL, as described in ISO/IEC 9075-1:1999. The SQL language has established itself as the lingua franca for relational database management and provides the basis for systems interoperability, application portability, client/server operation, and distributed databases. XQuery is proposed to fulfill a similar same role with respect to XML database systems. As XML becomes the standard for information exchange between peer data stores, and between client visualization tools and data servers, XQuery may become the standard method for storing and retrieving data from XML databases.

With SQL query systems, much work has been done on the issue of efficiency, such as how to process a query, retrieve matching data and present that to the human or computer query issuer with efficient use of computing resources to allow responses to be quickly made to queries. As XQuery and other tools are relied on more and more for querying XML documents, efficiency will be more essential.

As noted above, XML documents are generally text files. As larger and more complex data structures are implemented in XML, updating or accessing these text files becomes difficult. For example, modifying data can require reading the entire text file into memory, making the changes, and then writing back the text file to persistent storage. It would be desirable to provide a more efficient way of storing and managing XML document data to facilitate accessing and/or updating information.

### BRIEF SUMMARY OF THE INVENTION

In embodiments of structured database systems according to the present invention, structured hierarchical documents containing data, such as XML documents, are input and stored in a structured database such as an XML database, with the hierarchy of a document being stored and handled as a collection of subtrees, wherein at least one subtree represents a plurality of nodes of a structured hierarchical document including a root node and other nodes that are descendant nodes of the root node. Relationships between subtrees are maintained by including a link node in each subtree; the link node stores a reference to a neighboring subtree.

According to one aspect of the present invention, a method for handling structured data is provided. The method comprises: (a) parsing the structured data into a plurality of related nodes; (b) detecting a subtree root node in the plurality of related nodes, the subtree root node identifying a division point between an upper subtree and a lower subtree, each of the upper subtree and the lower subtree including at least one node and the lower subtree including the subtree root node; (c) identifying, in the upper subtree, a parent node of the subtree root node; and (d) creating a first link node for the upper subtree and a second link node for the lower subtree, wherein the first link node includes a reference to the lower subtree and the second link node includes a reference to the upper subtree.

According to another aspect of the present invention, a system for handling structured data includes a parser, a builder module, and a storage space. The parser is configured to receive the structured data and to decompose the structured data into a plurality of subtrees including at least an upper subtree and a lower subtree, wherein the upper subtree and the lower subtree are connected at a subtree root node. The builder module is configured to generate a subtree data structure for each of the plurality of subtrees including a first subtree data structure corresponding to the upper subtree and a second subtree data structure corresponding to the lower subtree. The first subtree data structure includes a first link node that contains a reference to the second subtree data structure and the second subtree data structure includes a second link node that contains a reference to the first subtree data structure. The storage space is configured to store the subtree data structures generated by the builder module.

In specific implementations, subtrees might be organized into stands that can be treated as read-only objects in many respects. In such implementations, a subtree may be updated by marking it as deleted (or obsolete) in its current stand and generating a new subtree holding the updated data, either in the same stand or in a different stand. A plurality of stands might be organized as a “forest,” which provides a body of data over which queries are applied. A server, or array of servers, might host one or more forests.

According to another aspect of the present invention, XML documents or other hierarchical structured documents are stored as collections of subtrees, where each subtree contains the information appearing at or below a selected element in a document, directly or at least indirectly. Each subtree is stored as a contiguous block in the database and may be retrieved with a single ‘read’ operation. Subtrees can be linked together by including in each subtree a node (referred to herein as a link node) referencing another subtree that contains a neighboring node. The subtrees may be stored directly in an underlying file system, within a relational database table, or in other database structure.

The following detailed description together with the accompanying drawings will provide a better understanding of the nature and advantages of the present invention.

### BRIEF DESCRIPTION OF THE DRAWINGS

FIG. 1 is an illustration of a conventional XML document.

FIG. 2 is an illustration of an XQuery query.

FIG. 3 is an illustration of a simple XML document including text and markup.

FIG. 4 is a schematic representation of the XML document shown in FIG. 3; FIG. 4A illustrates a complete representation of the XML document and FIG. 4B illustrates a subtree of the XML document.

FIG. 5 is a more concise schematic representation of an XML document.

FIG. 6 illustrates a portion of an XML document that includes tags with attributes;

FIG. 6A shows the portion in XML format; FIG. 6B is a schematic representation of that portion in graphical form.

FIG. 7 shows a more complex example of an XML document, having attributes and varying levels.

FIG. 8 is a schematic representation of the XML document shown in FIG. 7, omitting data nodes.

FIG. 9 illustrates one decomposition of the XML document illustrated in FIGS. 7-8.

FIG. 10 illustrates the decomposition of FIG. 9 with the addition of link nodes.

FIG. 11 is a detail of a link node structure from the decomposition illustrated in FIG. 10.

FIG. 12A is a block diagram representing elements of a subtree data structure according to an embodiment of the present invention.

FIG. 12B is a simplified block diagram of elements of a data structure for storing atom data according to an embodiment of the present invention.

FIG. 13 is a simplified block diagram of a database system according to an embodiment of the present invention.

FIG. 14 is a simplified block diagram of a parser for a database system according to an embodiment of the present invention.

FIG. 15 is a block diagram showing elements of a database according to an embodiment of the present invention.

FIG. 16 is a flow diagram of a process for creating a subtree according to an embodiment of the present invention.

FIGS. 17A-B are flow diagrams of a process for updating a subtree in an on-disk stand according to an embodiment of the present invention.

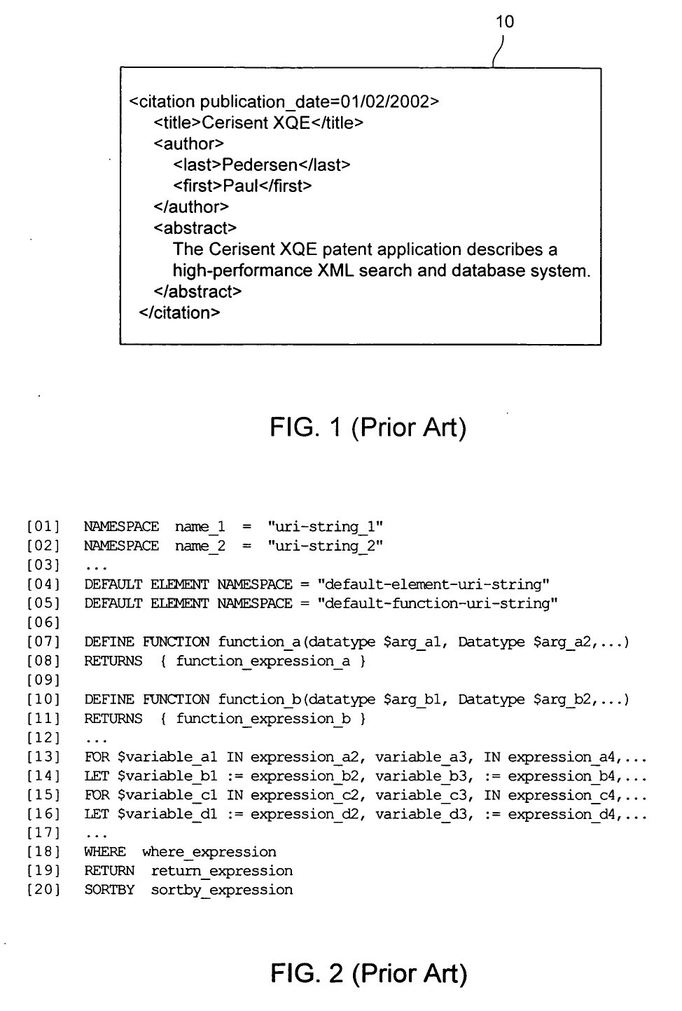

### DETAILED DESCRIPTION OF THE INVENTION

This detailed description illustrates some embodiments of the invention and variations thereof, but should not be taken as a limitation on the scope of the invention. In this description, structured documents are described, along with their processing, storage and use, with XML being the primary example. However, it should be understood that the invention might find applicability in systems other than XML systems, whether they are later-developed evolutions of XML or entirely different approaches to structuring data. It should also be understood that “XML” is not limited to the current version or versions of XML. An XML file (or XML document) as used herein can be serialized XML or more generally an “infoset”. Generally, XML files are text, but they might be in a highly compressed binary form.

Subtree Decomposition

In an embodiment of the present invention, an XML document (or other structured document) is parsed into “subtrees” for efficient handling. An example of an XML document and its decomposition is described in this section, with following sections describing apparatus, methods, structures and the like that might create and store subtrees. Subtree decomposition is explained with reference to a simple example, but it should be understood that such techniques are equally applicable to more complex examples.

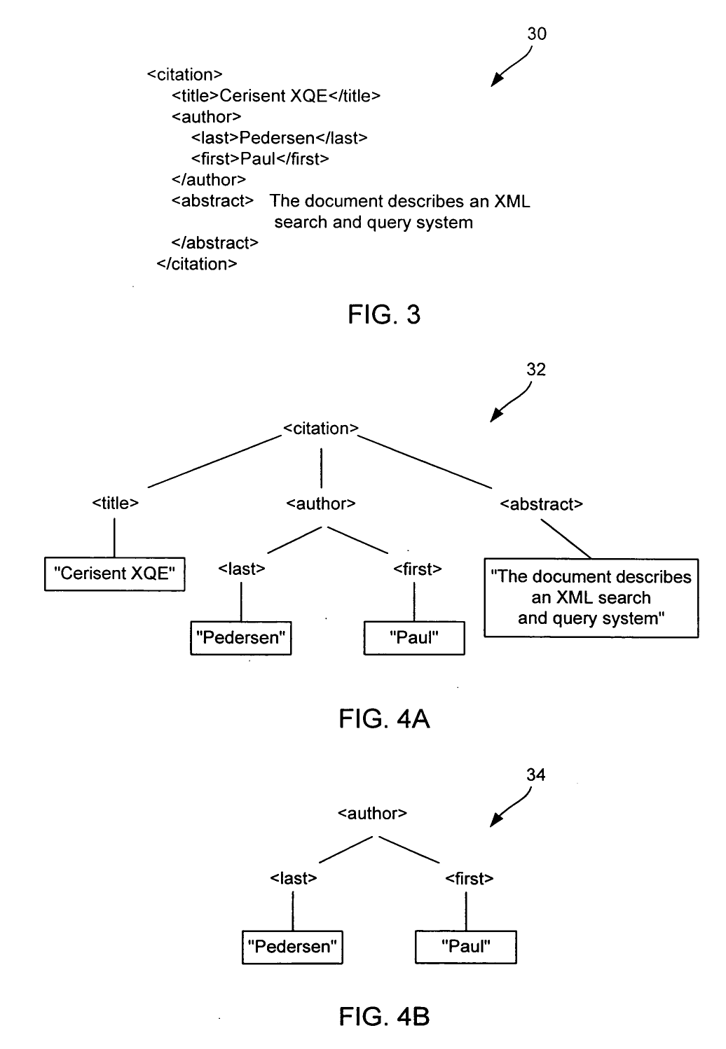

FIG. 3 illustrates an XML document 30, including text and markup. FIG. 4A illustrates a schematic representation 32 of XML document 30, wherein schematic representation 12 is a shown as a tree (a connected acyclic simple directed graph) with each node of the tree representing an element of the XML document or an element's content, attribute, the value, etc.

In a convention used for the figures of the present application, directed edges are oriented from an initial node that is higher on the page than the edge's terminal node, unless otherwise indicated. Nodes are represented by their labels, often with their delimiters. Thus, the root node in FIG. 4A is a “citation” node represented by the label delimited with “< >”. Data nodes are represented by rectangles. In many cases, the data node will be a text string, but other data node types are possible. In many XML files, it is possible to have a tag with no data (e.g., where a sequence such as “<tag> </tag>” exists in the XML file). In such cases, the XML file can be represented as shown in FIG. 4A but with some nodes representing tags being leaf nodes in the tree. The present invention is not limited by such variations, so to focus explanations, the examples here assume that each “tag” node is a parent node to a data node (illustrated by a rectangle) and a tag that does not surround any data is illustrated as a tag node with an out edge leading to an empty rectangle. Alternatively, the trees could just have leaf nodes that are tag nodes, for tags that do not have any data.

As used herein, “subtree” refers to a set of nodes with a property that one of the nodes is a root node and all of the other nodes of the set can be reached by following edges in the orientation direction from the root node through zero or more non-root nodes to reach that other node. A subtree might contain one or more overlapping nodes that are also members of other “inner” or “lower” subtrees; nodes beyond a subtree's overlapping nodes are not generally considered to be part of that subtree. The tree of FIG. 4A could be a subtree, but the subtree of FIG. 4B is more illustrative in that it is a proper subset of the tree illustrated in FIG. 4A.

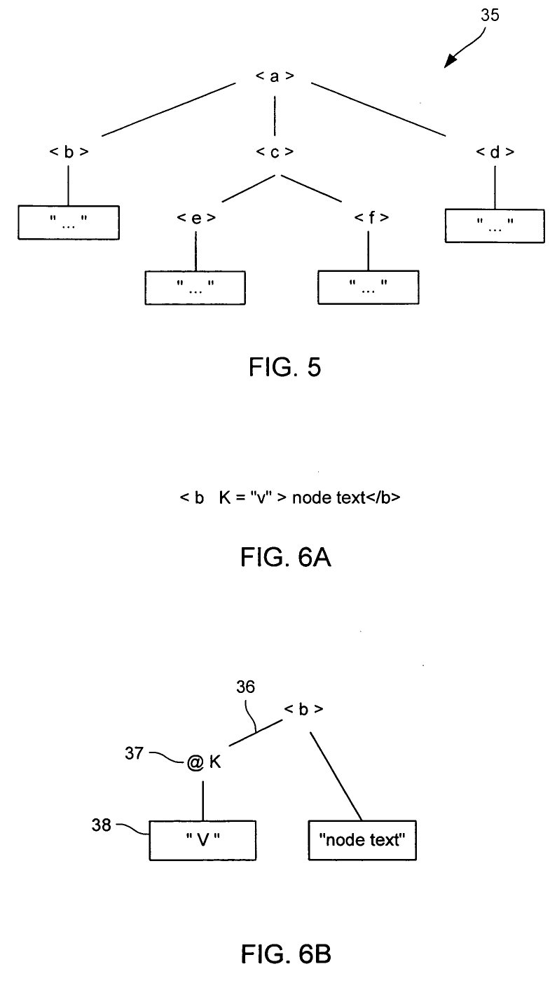

To simplify the following description and figures, single letter labels will be used, as in FIG. 5. Note that even with the shortened tags, tree 35 in FIG. 5 represents a document that has essentially the same structure as the document represented by the tree of FIG. 4A.

Some nodes may contain one or more attributes, which can be expressed as (name, value) pairs associated with nodes. In graph theory terms, the directed edges come in two flavors, one for a parent-child relationship between two tags or between a tag and its data node, and one for linking a tag with an attribute node representing an attribute of that tag. The latter is referred to herein as an “attribute edge”. Thus, adding an attribute (key, value) pair to an XML file would map to adding an attribute edge and an attribute node, followed by an attribute value node to a tree representing that XML file. A tag node can have more than one attribute edge (or zero attribute edges). Attribute nodes have exactly one descendant node, a value node, which is a leaf node and a data node, the value of which is the value from the attribute pair.

In the tree diagrams used herein, attribute edges sometimes are distinguished from other edges in that the attribute name is indicated with a preceding “@”. FIG. 6A illustrates a portion of XML markup wherein a tag T has an attribute name of “K” and a value of “V”. FIG. 6B illustrates a portion of a tree that is used to represent the XML markup shown in FIG. 6A, including an attribute edge 36, an attribute node 37 and a value node 38. In some instances, tag nodes and attribute nodes are treated the same, but at other times they are treated differently. To easily distinguish tag nodes and attribute nodes in the illustrated trees, tag nodes are delimited with surrounding angle brackets (“< >”), while attribute nodes are delimited with an initial “@”.

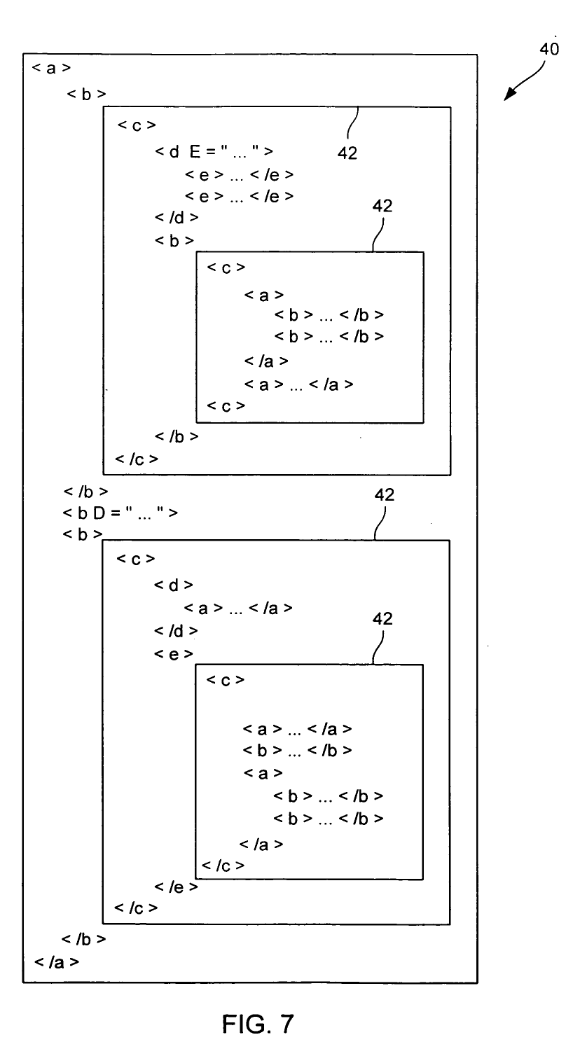

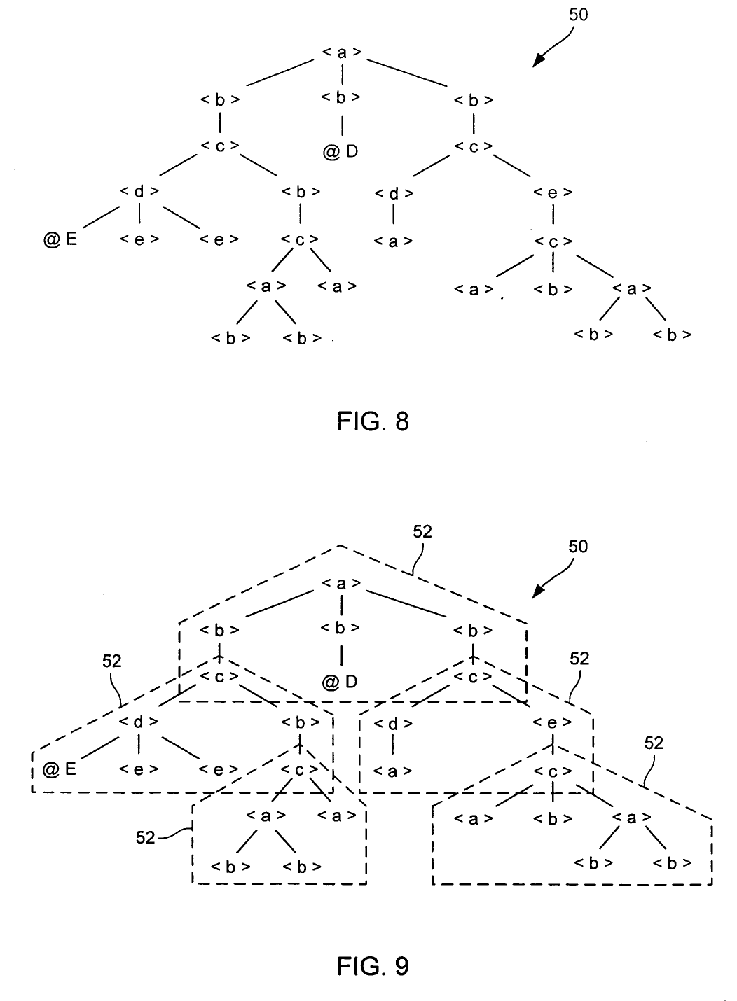

FIG. 7 et seq. illustrate a more complex example, with multiple levels of tags, some having attributes. FIG. 7 shows a multi-level XML document 40. As is explained later below, FIG. 7 also includes indications 42 of where multi-level XML document 40 might be decomposed into smaller portions. FIG. 8 illustrates a tree 50 that schematically represents multi-level XML document 40 (with a data nodes omitted).

FIG. 9 shows one decomposition of tree 50 with subtree borders 52 that correspond to indications 42. Each subtree border 52 defines a subtree; each subtree has a subtree root node and zero or more descendant nodes, and some of the descendant nodes might in turn be subtree root nodes for lower subtrees. In this example, the decomposition points are entirely determined by tag labels (e.g., each tag with a label “c” becomes a root node for a separate subtree, with the original tree root node being the root node of a subtree extending down to the first instances of tags having tag labels “c”). In other examples, decomposition might be done using a different set of rules. For example, the decomposition rules might be to break at either a “c” tag or an “f” tag, break at a “d” tag when preceded by an “r” tag, etc. Decomposition rules need not be specific to tag names, but can specify breaks upon occurrence of other conditions, such as reaching a certain size of subtree or subtree content. Some decomposition rules might be parameterized where parameters are supplied by users and/or administrators (e.g., “break whenever a tag is encountered that matches a label the user specifies”, or more generally, when a user-specified regular expression or other condition occurs).

Note from FIG. 9 that subtrees overlap. In a subtree decomposition process, such as one prior to storing subtrees in a database or processing subtrees, it is often useful to have nonoverlapping subtree borders. Assume that two subtrees overlap as they both include a common node (specifically, the subtree root node). The subtree that contains the common node and parent(s) of the common node is referred to herein as the upper overlapping subtree, while the subtree that contains the common node and child(ren) of the common node is referred to herein as the lower overlapping subtree.

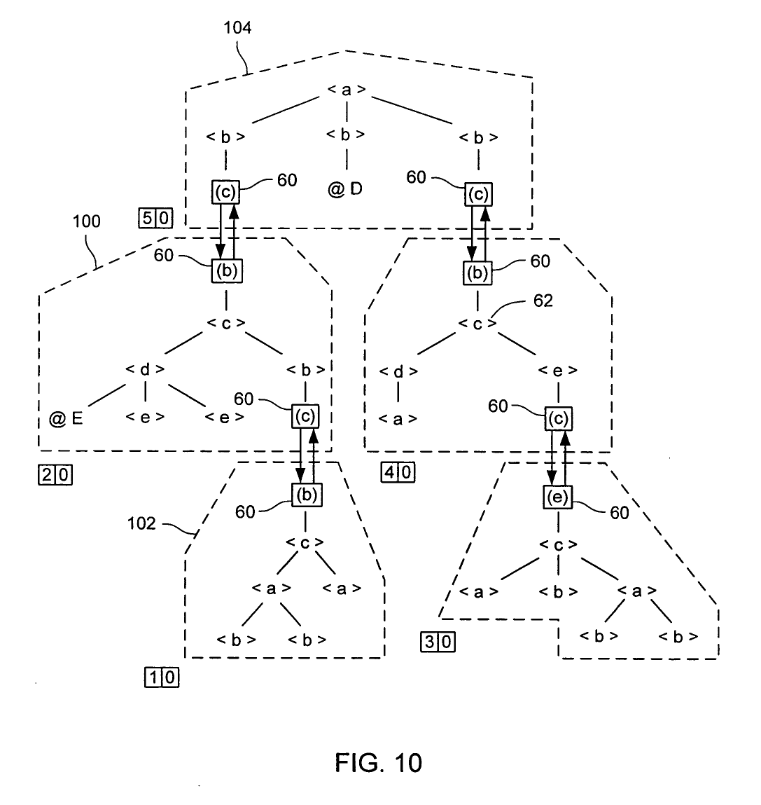

FIG. 10 illustrates one approach to providing nonoverlapping subtrees, namely by introducing the construct of link nodes 60. For each common node, an upper link node is added to the upper subtree and a lower link node is added to the lower subtree. These link nodes are shown in the figures by squares. The upper link node contains a pointer to the lower link node, which in turn contains a pointer to the root node of the lower overlapping subtree (which was the common node), while the lower link node contains a pointer to the upper link node, which in turn contains a pointer to the parent node of what was the common node. Each link node might also hold a copy of the other link node's label possibly along with other information. Thus, the upper link node may hold a copy of the lower subtree's root node label and the lower link node may hold a copy of the upper subtree's node label for the parent of what was the common node.

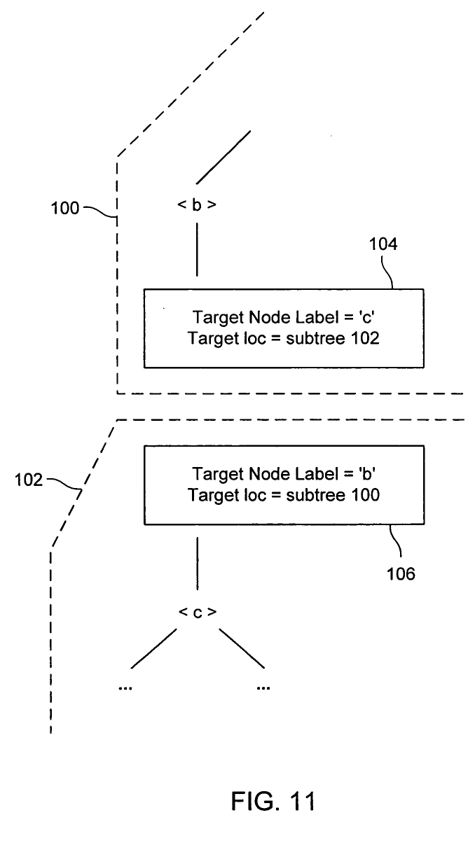

The pointer in a link node advantageously does not reference the other link node specifically; instead the pointer advantageously references the subtree in which the other link node can be found. FIG. 11 illustrates contents of the link nodes for two of the subtrees (labeled 101 and 102) of FIG. 10. Upper link node 104 of subtree 100 contains a target node label (‘c’) and a pointer to a target location that stores an identifier of subtree 102, which does not precisely identify lower link node 106. Similarly, lower link node 106 contains a target node label (‘b’) and a pointer to a target location that stores an identifier of subtree 100, which does not precisely identify upper link node 104.

Navigation from lower link node 106 to upper link node 104 (and vice versa) is nevertheless possible. For instance, the target location of lower link node 106 can be used to obtain a data structure for subtree 100 (an example of such a data structure is described below). The data structure for subtree 100 includes all seven of the nodes shown for subtree 100 in FIG. 10. Two of these are link nodes (labeled 60 in FIG. 10) that contain the target node label ‘c.’ These nodes, however, are distinguishable because their target location pointers point to different subtrees. Thus, the correct target node 104 for lower link node 106 can be identified by searching for a link node in subtree 100 whose target location is subtree 102. Similarly, the correct target node 106 for upper link node 104 can also be found by a search in subtree 102, enabling navigation in the other direction. Searching can be made highly efficient, e.g., by providing a hash table in subtree 100 that accepts a subtree identifier (e.g., for subtree 102) and returns the location of the link node that references that subtree.

Using a reference scheme that connects a link node to a target subtree (rather than to a particular node within the target subtree) makes lower link node 106 insensitive to changes in subtree 100. For instance, a new node may be added to subtree 100, causing the storage location of upper link node 104 to change. Lower link node 106 need not be modified; it can still reference subtree 100 and be able to locate upper link node 104. Likewise, upper link node 104 is insensitive to changes in subtree 102 that might affect the location of lower link node 106. This increases the modularity of the subtree structure. Subtree 100 can be modified without affecting link node 106 as long as link node 104 is not deleted. (If link node 104 is deleted, then subtree 102 is likely to be deleted as well.) Similarly, subtree 102 can be modified without affecting link node 104; if subtree 102 is deleted, then link node 104 will likely be deleted as well. Handling subtree updates that affect other subtrees is described in detail in Lindblad IIIA.

It should be noted that this indirect indexing approach is reliable as long as cyclic connections between subtrees are not allowed, i.e., as long as subtree 100 has only one node that connects to subtree 102 and vice versa. Those of ordinary skill in the art will appreciate that non-circularity is an inherent feature of XML and numerous other structured document formats.

Subtree Data Structure

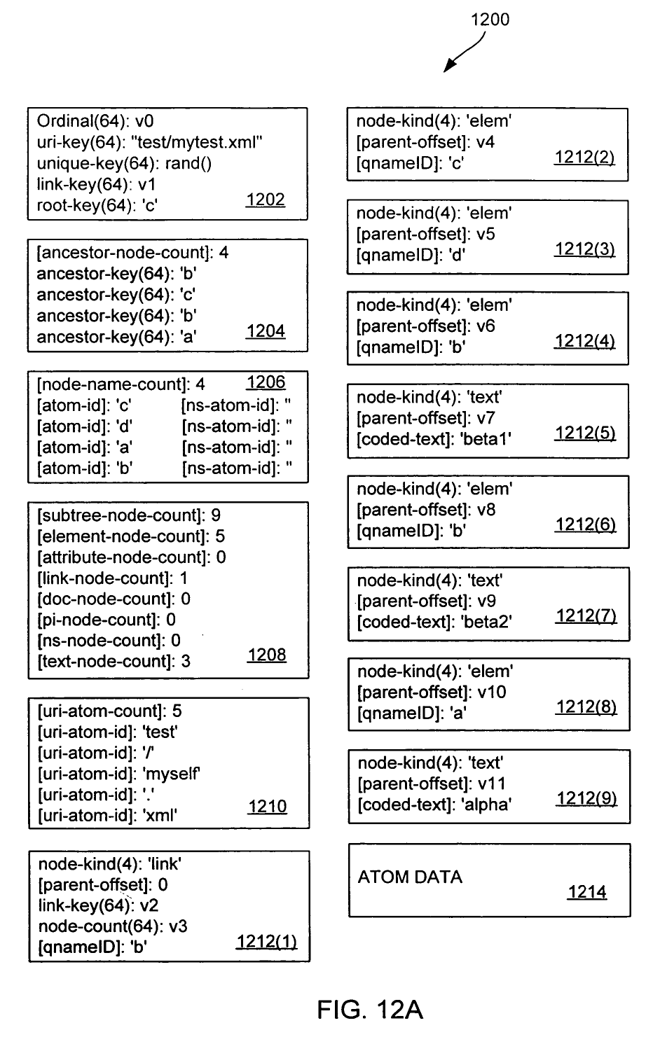

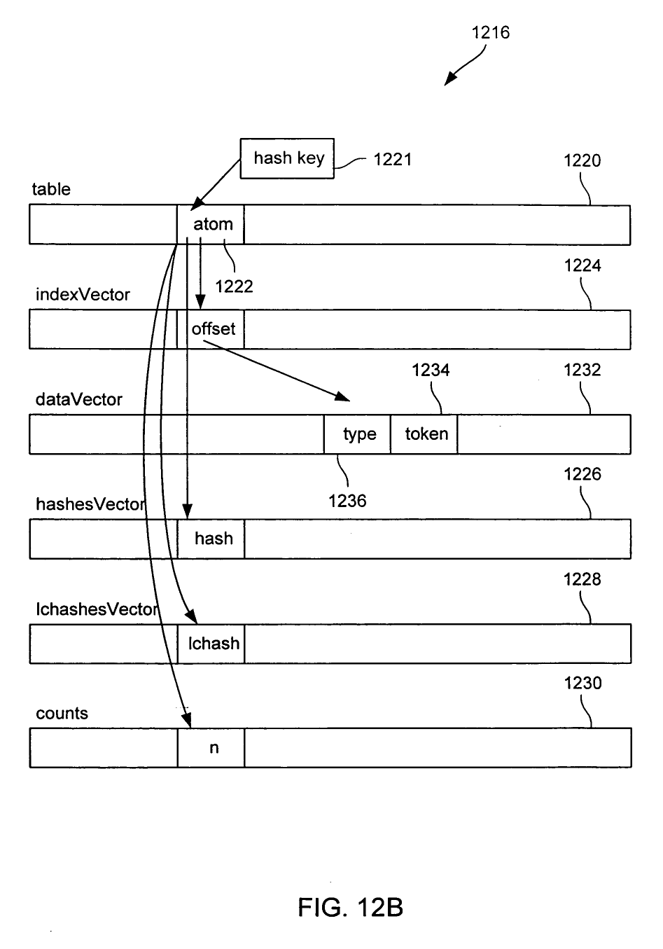

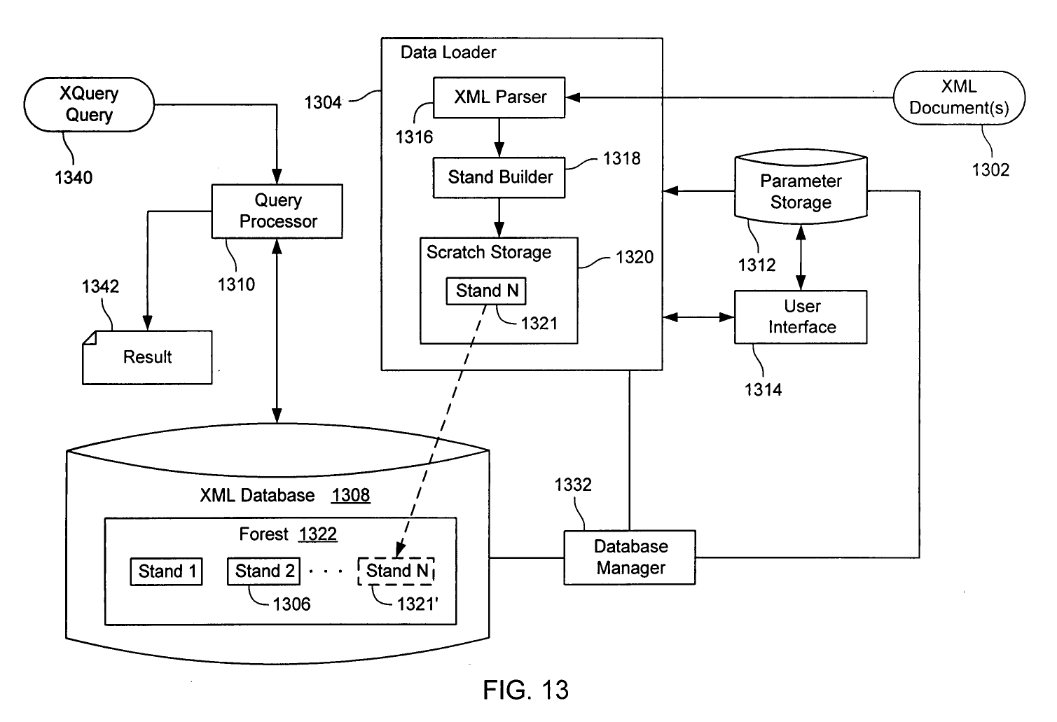

Each subtree can be stored as a data structure in a storage area (e.g., in memory or on disk), preferably in a contiguous region of the storage area. FIG. 12A illustrates an example of a data structure 1200 for storing subtree 102 of FIG. 10. In general, any subtree can be stored using a data structure similar to that of FIG. 12A.

In FIG. 12A, the following notational conventions are used: field(0:n-1): v describes a fixed-width N-bit field named ‘field’ and storing a value corresponding to ‘v’ (which might be an encoded version of v; examples are described below), and [field] describes a variable bit width field encoded using a unary-log-log encoding. The unary-log-log encoding represents an integer value N as follows: (a) compute the number of bits=log₂ (N) needed to represent the integer N; (b) compute the number of bits=log₂(log₂ (N)) needed to represent log₂ (N); (c) encode the integer as log₂ (log₂ (N)) in unary, i.e., a sequence of log₂ (log₂ (N)) bits all equal to 1 terminated by 0 (or similar coding), followed by the bits needed to actually represent log₂ (N), followed by the bits actually needed to represent N. Text data values are generally stored in a format referred to herein as “CodedText,” in which the text string is parsed into one or more tokens and encoded as “[length], [atomID1], [atomID2], [atomID3], . . . ,” where the length is the unary-encoded length of the list of atomIDs, and each atomID is a code that corresponds to one of the tokens. Associations of atomIDs with specific tokens are provided by an atom data block 1214, which is shown in detail in FIG. 12B and described further below.

As shown in FIG. 12A, the subtree data is organized into various blocks. Header block 1202 contains identifying information for the subtree. Ancestry block 1204 provides information about the ancestor nodes of the subtree, tracing back to the ultimate parent node of the XML document. As FIG. 10 shows, subtree 102 has four ancestor nodes (not counting the link nodes): the parent of the subtree root node <c> is node <b> in subtree 102, whose parent is node <c>, whose parent is node <b> in subtree 104, whose parent is the ultimate root node <a>. Node name block 1206 provides the tags (encoded as atomIDs) for the element nodes in subtree 102. Subtree size block 1208 indicates the number of various kinds of nodes in subtree 102. URI information block 1210 provides (using atomIDs) the URI of the XML document to which subtree 102 belongs. The remaining node blocks 1212(1)-1212(9) provide information about each node of the subtree: the type of node, a reference to the node's parent, and other parameters appropriate for the node type. It is to be understood that the number of node blocks may vary, depending on the number of given nodes in the subtree. More specific information about the various elements of subtree data structure 1200 is listed in Table 1 and data types for representative types of nodes are listed in Table 2.

TABLE 1
Subtree Elements

| Block | Item | Description |
|---|---|---|
| Header | ordinal | Sequentially allocated node count for first node |
| | | in subtree |
| | uri-key | Hash value of URI of the document containing |
| | | the subtree |
| | unique-key | Random 64-bit key |
| | link-key | Random 64-bit key that is constant across saves. |
| | root-key | Hash subtree checksum |
| | [ancestor-node-count] | Coded count of number of ancestors (can be an |
| | | estimate) |
| | ancestor-key | Hash key of each ancestor subtree (repeated for |
| | | each ancestor) |
| Ancestry | [node-name-count] | Coded number of QNames (a QName might be a |
| | | namespace URI and a local name) element tags |
| | | in the subtree |
| | [atomID] | Coded Atom ID of element QName (repeated |
| | | for each element tag) |
| Node | [nsURI-atomID] | Coded Atom ID of element QName associated |
| name | | namespace (repeated for each element tag) |
| | [subtree-node-count] | Coded total number of nodes of all types in the |
| | | subtree |
| | [element-node-count] | Coded total number of element nodes in the |
| | | subtree |
| Subtree | [attribute-node-count] | Coded total number of attribute nodes in the |
| size | | subtree |
| | [link-node-count] | Coded total number of link nodes in the subtree |
| | [doc-node-count] | Coded total number of doc nodes in the subtree |
| | [pi-node-count] | Coded total number of processing instruction |
| | | nodes in the subtree |
| | [namespace-node-count] | Coded total number of namespace nodes in the |
| | | subtree |
| | [text-node-count] | Coded total number of text nodes in the subtree |
| | [uri-atom-count] | Coded count of tokens in the document URI |
| | [uri-atom-id] | Coded Atom ID(s) of each token of the |
| | | document URI |
| URI info | node-kind | See Table 2; one of: elem, attr, text, link, doc, |
| | | PI, ns, comment, etc. |
| | [parent-offset] | Coded implicitly negative offset (base 1) to |
| | | parent |
| Node | data element(s) | The content of the data element(s) depends on |
| | | the kind of node (specified by the node-kind |
| | | field). Table 2 lists some data element types that |
| | | might be used. This can comprise textual |
| | | representation of the data as a compressed list of |
| | | Atom IDs of the content of the element. |

TABLE 2
Data Element Types for Subtree Nodes

| Node Type | Data Field | Description |
|---|---|---|
| elem | [qnameID] | Coded element QName Atom ID |
| attr | [qnameID] | Coded attribute QName Atom ID |
| | CodedText | Coded text representing the attribute's value |
| text | CodedText | Coded text representing the text node value |
| PI | [PI-target-atomID] | Processing Instruction (typically opaque to the XQE |
| | | XML database) |
| | CodedText | Coded Atom ID of PI target |
| | CodedText | Coded text of PI |
| link | link-key | Link to parent/child subtree; bi-directional |
| | [qnameID] | Coded QName Atom ID of link-key target |
| | [node-count] | Coded initial ordinal for subtree nodes [?????] |
| comment | CodedText | Coded text of comment |
| docnode | CodedText | Coded text of docnode uri |
| ns | [delta-ordinal] | Coded ordinal of element containing the ns decl, delta |
| | | from last ns-decl |
| | [offset] | Coded offset in namespace list of preceding |
| | | namespace node |
| | [prefix-atomID] | Coded Atom ID of namespace prefix |
| | [nsURI-atomID] | Coded Atom ID of namespace URI |

It should be noted that each link node (such as described above with reference to FIG. 11) has a corresponding node block in the subtree data structure 1200; e.g., node block 1212(1) describes a link node, as indicated by the node-kind (‘link’). For the link node, the stored data includes a link-key element, a qname element, and a number-of-nodes element. The link-key element provides the reference to the subtree that contains the target node; for instance, value (v2) stored in the link key of node block 1212(1) may correspond to the link-key element that is stored in a lead block 1212 of a different subtree data structure that contains the target node. As noted in Table 1, the link-key element is defined so as to be constant across saves, making it a reliable identifier of the target subtree. Other identifiers could also be used. The qnameID element of node block 1212(1) stores (as an atomID) the QName of the target of the link identified by the link-key element. The QName might be just the tag label or a qualified version thereof (e.g., with a namespace URI prepended).

In the case where link node block 1212(1) corresponds to link node 106 of FIG. 11, the link-key value v2 identifies a data structure for subtree 100, and the qnameID corresponds to ‘b’. The node-count encodes an initial ordinal for the subtree nodes. Similar node blocks can be provided for nodes that link to child subtrees. In this manner, the connections between subtrees are reflected in the data structure.

As shown in FIG. 12A and Table 1, every node, regardless of its node-kind, includes a parent-offset element. This element represents the relationship between nodes in a unidirectional manner by providing, for each node, a way of identifying which node is its parent. For example, the value of a parent-offset element might be a byte offset reflecting the location of the parent node block within the data structure relative to the current node block. For link nodes whose parents are not in the subtree, a value of 0 can be used, as in block 1212(1). In the case of XML input documents, the byte offset can be implicitly negative as long as nodes appear in the data structure in the order they occur in the document, because the parent node will always precede the child. In other document formats or subtree data structures, parents might occur after the child and positive offsets would be allowed. In general, the node blocks may be placed in any order within data structure 1200, as long as the parent-offset values correctly reflect the hierarchical relationship of the nodes.

Atom data block 1214 is shown in detail in FIG. 12B. In this embodiment, atom data block 1214 implements a token heap, i.e., a system for compactly storing large numbers of tokens. A given token is hashed to produce a hash key 1221 that is used as an index into a “table” array 1220, which is a fixed-width array. The atom value 1222 stored in the table array at the hash key index position represents a cursor (or offset) into four other arrays: indexVector 1224, hashesVector 1226, 1chashesVector 1228, and counts 1230. The offset stored at the atom index position in the (fixed-width) indexVector array 1224 represents an offset into the (variable-width) dataVector array 1232 where the actual token 1234 is stored along with one 8-bit byte of type information 1236; additional bits may also be provided for other uses. In this embodiment, the type of a token can be one of ‘s’ (space character), ‘p’ (punctuation character), or ‘w’ (word character); other types may also be supported. The atom value 1222 also indexes into the (fixed-width) hashesVector array 1228 and the (fixed-width) 1cHashesVector array 1230. These two vector arrays are used as caches for token hash keys, and lower-cased token hash keys, and are provided to facilitate indexing and/or search operations. The atom value 1222 also indexes into the counts array 1230, where token multiplicities are stored, that is to say, each token is stored uniquely (i.e., once per subtree) in the dataVector array 1232, but the count describing the number of times the token appeared in the subtree is stored in the counts array 1230. This avoids the necessity of having to access multiple subtrees to count occurrences every time such information is needed.

It will be appreciated that the data structure described herein for storing subtree data is illustrative and that variations and modifications are possible. Different fields and/or field names may be used, and not all of the data shown herein is required. The particular coding schemes (e.g., unary coding, atom coding) described herein need not be used; different coding schemes or unencoded data may be stored. The arrangement of data into blocks may also be modified without restriction, provided that it is possible to determine which nodes are associated with a particular subtree and to navigate hierarchically between subtrees. Further, as described below, subtree data can be found in scratch space, in memory and on disk, and implementation details of the subtree data structure, including the atom data substructure, may vary within the same embodiment, depending on whether an in-scratch, in-memory, or on-disk subtree is being provided.

Database Management System

System Overview

According to one embodiment of the invention, a computer database management system is provided that parses XML documents into subtree data structures (e.g., similar to the data structure described above), and updates the subtree data structures as document data is updated. The subtree data structures may also be used to respond to queries.

A typical XML handling system according to one embodiment of the present invention is illustrated in FIG. 13. As shown there, system 1300 processes XML (or other structured) documents 1302, which are typically input into the system as files, streams, references or other input or file transport mechanisms, using a data loader 1304. Data loader 1304 processes the XML documents to generate elements (referred to herein as “stands”) 1306 for an XML database 1308 according to aspects of the present invention. System 1300 also includes a query processor 1310 that accepts queries 1340 against structured documents, such as XQuery queries, and applies them against XML database 1308 to derive query results 1342.

System 1300 also includes parameter storage 1312 that maintains parameters usable to control operation of elements of system 1300 as described below. Parameter storage 1312 can include permanent memory and/or changeable memory; it can also be configured to gather parameters via calls to remote data structures. A user interface 1314 might also be provided so that a human or machine user can access and/or modify parameters stored in parameter storage 1312.

Data loader 1304 includes an XML parser 1316, a stand builder 1318, a scratch storage unit 1320, and interfaces as shown. Scratch storage 1320 is used to hold a “scratch” stand 1321 (also referred to as an “in-scratch stand”) while it is in the process of being built by stand builder 1318. Building of a stand is described below. After scratch stand 1321 is completed (e.g., when scratch storage 1320 is full), it is transferred to database 1308, where it becomes stand 1321′.

System 1300 might comprise dedicated hardware such as a personal computer, a workstation, a server, a mainframe, or similar hardware, or might be implemented in software running on a general purpose computer, either alone or in conjunction with other related or unrelated processes, or some combination thereof. In one example described herein, database 1308 is stored as part of a storage subsystem designed to handle a high level of traffic in documents, queries and retrievals. System 1300 might also include a database manager 1332 to manage database 1308 according to parameters available in parameter storage 1312.

System 1300 reads and stores XML schema data type definitions and maintains a mapping from document elements to their declared types at various points in the processing. System 1300 can also read, parse and print the results of XML XQuery expressions evaluated across the XML database and XML schema store.

Forests, Stands, and Subtrees

In the architecture described herein, XML database 1308 includes one or more “forests” 1322, where a forest is a data structure against which a query is made. In one embodiment, a forest 1322 encompasses the data of one or more XML input documents. Forest 1322 is a collection of one or more “stands” 1306, wherein each stand is a collection of one or more subtrees (as described above) that is treated as a unit of the database. The contents of a stand in one embodiment are described below. In some embodiments, physical delimitations (e.g., delimiter data) are present to delimit subtrees, stands and forests, while in other embodiments, the delimitations are only logical, such as by having a table of memory addresses and forest/stand/subtree identifiers, and in yet other embodiments, a combination of those approaches might be used.

In one implementation, a forest 1322 contains some number of stands 1306, and all but one of these stands resides in a persistent on-disk data store (shown as database 1308) as compressed read-only data structures. The last stand is an “in-memory” stand (not shown) that is used to re-present subtrees from on-disk stands to system 1300 when appropriate (e.g., during query processing or subtree updates). System 1300 continues to add subtrees to the in-memory stand as long as it remains less than a certain (tunable) size. Once the size limit is reached, system 1300 automatically flushes the in-memory stand out to disk as a new persistent (“on-disk”) stand.

Data Flow

Two main data flows into database 1308 are shown. The flow on the right shows XML documents 1302 streaming into the system through a pipeline comprising an XML parser 1316 and a stand builder 1318. These components identify and act upon each subtree as it appears in the input document stream, as described below. The pipeline generates scratch data structures (e.g., a stand 1320) until a size threshold is exceeded, at which point the system automatically flushes the in-memory data structures to disk as a new persistent on-disk stand 1306.

The flow on the left shows processing of queries. A query processor 1310 receives a query (e.g., XQuery query 1340), parses the query, optimizes it to minimize the amount of computation required to evaluate the query, and evaluates it by accessing database 1308. For instance, query processor 1310 advantageously applies a query to a forest 1322 by retrieving a stand 1306 from disk into memory, apply the query to the stand in memory, and aggregate results across the constituent stands of forest 1322; some implementations allow multiple stands to be processed in parallel. Results 1342 are returned to the user. One such query system could be the system described in Lindblad IIA.

Queries to query processor 1310 can come from human users, such as through an interactive query system, or from computer users, such as through a remote call instruction from a running computer program that uses the query results. In one embodiment, queries can be received and responded to using a hypertext transfer protocol (HTTP). It is to be understood that a wide variety of query processors can be used with the subtree-based database described herein, and a detailed description of a particular query processor is omitted as not being crucial to understanding the present invention.

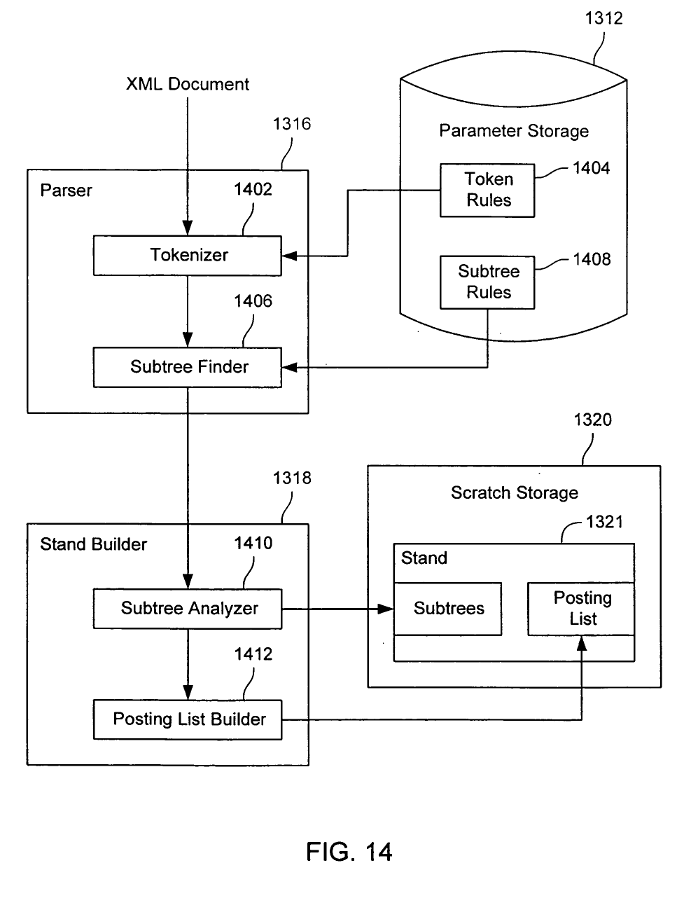

Processing of input documents will now be described. FIG. 14 shows parser 1316 and stand builder 1318 in more detail. As shown, parser 1316 includes a tokenizer 1402 that parses documents into tokens according to token rules stored in parameter storage 1312. As the input documents are normally text, or can normally be treated as text, they can be tokenized by tokenizer 1402 into tokens, or more generally into “atoms.” The text tokenizer identifies the beginning and ending of tokens according to tokenizing rules. Often, but not always, words (e.g., characters delimited by white space or punctuation) are identified as tokens. Thus, tokenizer 1402 might scan input documents and look for word breaks as defined by a set of configurable parameters included in token rules 1404. Preferably, tokenizer 1402 is configurable, handles Unicode inputs and is extensible to allow for language-specific tokenizers.

Parser 1316 also includes a subtree finder 1406 that allocates nodes identified in the tokenized document to subtrees according to subtree rules 1408 stored in parameter storage 1312. In one embodiment, subtree finder 1406 allocates nodes to subtrees based on a subtree root element indicated by the subtree rules 1408 Thus, an XML document is divided into subtrees from matching subtree nodes down. For example, if an XML document including citations was processed and the subtree root element was set to “citation”, the XML document would be divided into subtrees each having a root node of “citation”. In other cases, the division of subtrees is not strictly by elements, but can be by subtree size or tree depth constraints, or a combination thereof or other criteria.

Each subtree identified by subtree finder 1406 are provided to stand builder 1318, which includes a subtree analyzer 1410, a posting list generator 1412, and a key generator 1414. Subtree analyzer 1410 generates a subtree data structure (e.g., data structure 1200 of FIG. 12), which is added to the stand. Posting list generator 1412 generates data related to the occurrence of tokens in a subtree (e.g., parent-child index data as described in Lindblad IIA), which is also added to the stand. Stand builder 1318 may also include other data generation modules, such as a classification quality generator (not shown), that generate additional information on a per-subtree or per-stand basis and are stored as the stand is constructed. Classification quality information that might be included in system 1300 is described in Lindblad IV-A.

As stand builder 1318 generates the various data structures associated with subtrees, it places them into scratch stand 1320, which acts as a scratch storage unit for building a stand. The scratch storage unit is flushed to disk when it exceed a certain size threshold, which can be set by a database administrator (e.g., by setting a parameter in parameter storage 1312). In some implementations of data loader 1304, multiple parsers 1316 and/or stand builders 1318 are operated in parallel (e.g., as parallel processes or threads), but preferably each scratch storage unit is only accessible by one thread at a time.

Stand Structure

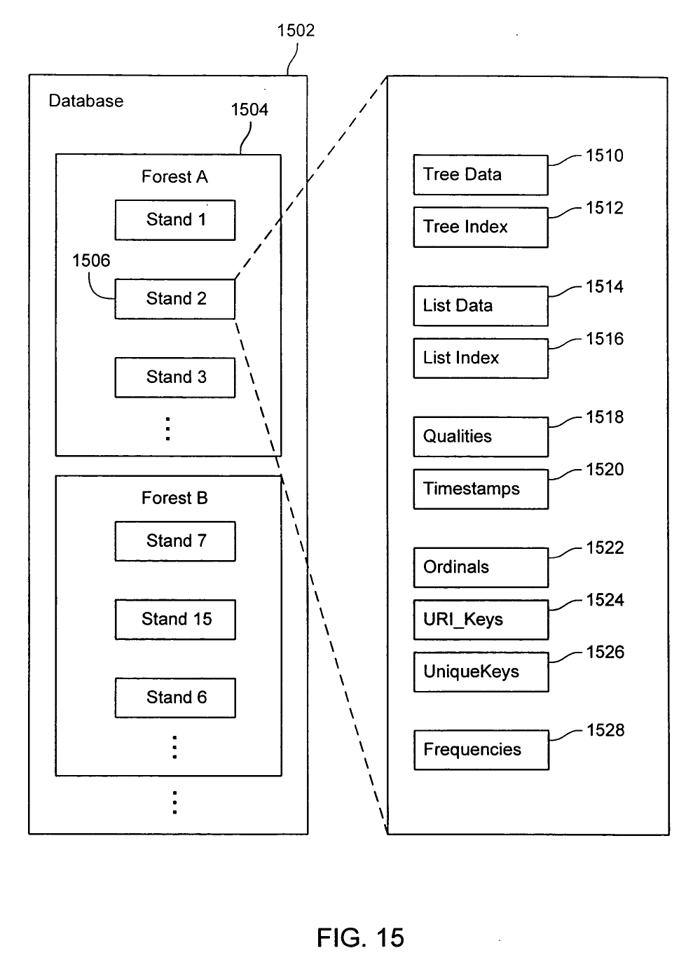

One example of a structure of an XML database used with the present invention is shown in FIG. 15. As illustrated there, database 1502 contains, among other components, one or more forest structures 1504.

Forest structure 1504 includes one or more stand structures 1506, each of which contains data related to a number of subtrees, as shown in detail for stand 1506. For example, stand 1506 may be a directory in a disk-based file system, and each of the blocks may be a file. Other implementations are also possible, and the description of “files” herein should be understood as illustrative and not limiting of the invention.

TreeData file 1510 includes the data structure (e.g., data structure 1200 of FIG. 12A) for each subtree in the stand. The subtree data structure may have variable length; to facilitate finding data for a particular subtree, a TreeIndex file 1512 is also provided. TreeIndex file 1512 provides a fixed-width array that, when provided with a subtree identifier, returns an offset within TreeData file 1510 corresponding to the beginning of the data structure for that subtree.

ListData file 1514 contains information about the text or other data contained in the subtrees that is useful in processing queries. For example, in one embodiment, ListData file 1514 stores “posting lists” of subtree identifiers for subtrees containing a particular term (e.g., an atom), and ListIndex file 1516 is used to provide more efficient access to particular terms in ListData file 1514. Examples of posting lists and their creation are described in detail in Lindblad IIA, and a detailed description is omitted herein as not being critical to understanding the present invention.

Qualities file 1518 provides a fixed-width array indexed by subtree identifier that encodes one or more numeric quality values for each subtree; these quality values can be used for classifying subtrees or XML documents. Numeric quality values are optional features that may be defined by a particular application. For example, if the subtree store contained Internet web pages as XHTML, with the subtree units specified as the <HTML> elements, then the qualities block could encode some combination of the semantic coherence and inbound hyper link density of each page. Further examples of quality values that could be implemented are described in Lindblad IVA, and a detailed description is omitted herein as not being critical to understanding the present invention.

Timestamps file 1520 provides a fixed-width array indexed by subtree identifier that stores two 64-bit timestamps indicating a creation and deletion time for the subtree. For subtrees that are current, the deletion timestamp may be set to a value (e.g., zero) indicating that the subtree is current. As described below, Timestamps file 1520 can be used to support modification of individual subtrees, as well as storing of archival information.

The next three files provide selected information from the data structure 1200 for each subtree in a readily-accessible format. More specifically, Ordinals file 1522 provides a fixed-width array indexed by subtree identifier that stores the initial ordinal for each subtree, i.e., the ordinal value stored in block 1202 of the data structure 1200 for that subtree; because the ordinal increments as every node is processed, the ordinals for different subtrees reflects the ordering of the nodes within the original XML document. URI-Keys file 1524 provides a fixed-width array indexed by subtree identifier that stores the URI key for each subtree, i.e., the uri-key value stored in block 1202 of the data structure 1200. Unique-Keys file 1526 provides a fixed-width array indexed by subtree identifier that stores the unique key for each subtree, i.e., the unique-key value stored in block 1202 of the data structure 1200. It should be noted that any of the information in the Ordinals, URI-Keys, and Unique-Keys files could also be obtained, albeit less efficiently, by locating the subtree in the TreeData file 1510 and reading its subtree data structure 1200. Thus, these files are to be understood as auxiliary files for facilitating access to selected, frequently used information about the subtrees. Different files and different combinations of data could also be stored in this manner.

Frequencies file 1528 stores a number of entries related to the frequency of occurrence of selected tokens, which might include all of the tokens in any subtrees in the stand or a subset thereof. In one embodiment, for each selected token, frequency file 1528 holds a count of the number of subtrees in which the token occurs.

It will be appreciated that the stand structure described herein is illustrative and that variations and modifications are possible. Implementation as files in a directory is not required; a single structured file or other arrangement might also be used. The particular data described herein is not required, and any other data that can be maintained on a per-subtree basis may also be included. Use of subtree data structure 1200 is not required; as described above, different subtree data structures may also be implemented.

Creation, Updating, and Deletion of Subtrees

As the stands of a forest are generated, processed and stored, they can be “log-structured”, i.e., each stand can be saved to a file system as a unit that is never edited (other than the timestamps file). To update a subtree, the old subtree is marked as deleted (e.g., by setting its deletion timestamp in Timestamps file 1520) and a new subtree is created. The new subtree with the updated information is constructed in a memory cache as part of an in-memory stand and eventually flushed to disk, so that in general, the new subtree may be in a different stand from the old subtree it replaces. Thus, any insertions, deletions and updates to the forest are processed by writing new or revised subtrees to a new stand. This feature localizes updates, rather than requiring entire documents to be replaced.

It should be noted that in some instances, updates to a subtree will also affect other subtrees; for instance, if a lower subtree is deleted, the link node in the upper subtree is preferably be removed, which would require modifying the upper subtree. Transactional updating procedures that might be implemented to handle such changes while maintaining consistency are described in detail in Lindblad 111A.

It is to be understood that marking a subtree as deleted does not require that the subtree immediately be removed from the data store. Rather than removing any data, the current time can be entered as a deletion timestamp for the subtree in Timestamps file 1520 of FIG. 15. The subtree is treated as if it were no longer present for effective times after the deletion time. In some embodiments, subtrees marked as deleted may periodically be purged from the on-disk stands, e.g., during merging (described below).

Merging of Stands

Stand size is advantageously controlled to provide efficient I/O, e.g., by keeping the TreeData file size of a stand close to the maximum amount of data that can be retrieved in a single I/O operation. As stands are updated, stand size may fluctuate. In some embodiments of the invention, merging of stands is provided to keep stand size optimized. For example, in system 1300 of FIG. 13, database manager 1332, or other process, might run a background thread that periodically selects some subset of the persistent stands and merges them together to create a single unified persistent stand.

In one embodiment, the background merge process can be tuned by two parameters: Merge-min-ratio and Merge-min-size, which can be provided by parameter storage 1312. Merge-min-ratio specifies the minimum allowed ratio between any two on-disk stands; once the ratio is exceeded, system 1300 automatically schedules stands for merging to reduce the maximum size ratio between any two on-disk stands. Merge-min-size limits the minimum size of any single on-disk stand. Stands below this size limit will be automatically scheduled for merging into some larger on-disk stand.

In the embodiment of a stand shown in FIG. 15, the merge process merges corresponding files between the two stands. For some files, merging may simply involve concatenating the contents of the files; for other files, contents may be modified as needed. As an example, two TreeData files can be merged by appending the contents of one file to the end of the other file. This generally will affect the offset values in the TreeIndex files, which are modified accordingly. Appropriate merging procedures for other files shown in FIG. 15 can be readily determined.

Timestamps

In one implementation, there are two timestamps per subtree. One marks the time the subtree becomes active, and another marks the time the subtree becomes deleted. The deletion timestamp is always greater than or equal to the activation timestamp. The timestamp part of the stand data structure is read/write, so timestamps can be changed.

For any given time value a subtree is in one of three states: nascent, active, or deleted. A subtree is in the nascent state if its activation timestamp is greater than or equal to the current time value. A subtree is in the active state if its activation timestamp is less than the current time, and its deletion timestamp is greater than or equal to the current time value. A subtree is in the deleted state if its deletion timestamp is less than the current time value.

The system includes an update clock it increments every time it commits an update. Committing an update includes activating zero or more nascent subtrees and deleting zero or more active subtrees. A nascent subtree is activated by setting the subtree activation timestamp to the current update clock value. An active subtree is deleted by setting the subtree deletion timestamp to the current update clock value.

During query evaluation, the current value of the update clock is determined at the start of query processing and used for the entire evaluation of the query. Since the clock value remains constant throughout the evaluation of the query, the state of the database remains constant throughout the evaluation of the query, even if updates are being performed concurrently.

When the database manager starts performing a merge, it first saves the current value of the update clock, and uses that value of the update clock for the entire duration of the merge. The stand merge process does not include in the output any subtrees deleted with respect to the saved update clock.

Subtree timestamp updates are allowed during the stand merge operation. To propagate any timestamp updates performed during the merge operation, at the very end of the merge operation the database manager briefly locks out subtree timestamp updates and migrates the subtree timestamp updates from the input stands to the output stand.

System Parameters

As described above, parameters can be provided using parameter storage 1312 to control various aspects of system operation. Parameters that can be provided include rules for identifying tokens and subtrees, rules establishing minimum and/or maximum sizes for on-disk and in-memory stands, parameters for determining whether to merge on-disk stands, and so on.

In one embodiment, some or all of these parameters can be provided using a forest configuration file, which can be defined in accordance with a preestablished XML schema. For example, the forest configuration file can allow a user to designate one or more ‘subtree root’ element labels, with the effect that the data loader, when it encounters an element with a matching label, loads the portion of the document appearing at or below the matching element subdivision as a subtree. The configuration file might also allow for the definition of ‘subtree parent’ element names, with the effect that any elements which are found as immediate children of a subtree parent will be treated as the roots of contiguous subtrees.

More complex rules for identifying subtree root nodes may also be provided via parameter storage 1312, for example, conditional rules that identify subtree root nodes based on a sequence of element labels or tag names. Subtree identification rules need not be specific to tag names, but can specify breaks upon occurrence of other conditions, such as reaching a certain size of subtree or subtree content. Some decomposition rules might be parameterized where parameters are supplied by users and/or administrators (e.g., “break whenever a tag is encountered that matches a label the user specifies,” or more generally, when a user-specified regular expression or other condition occurs). In general, subtree decomposition rules are defined so as to optimize tradeoffs between storage space and processing time, but the particular set of optimum rules for a given implementation will generally depend on the structure, size, and content of the input document(s), as well as on parameters of the system on which the database is to be installed, such as memory limits, filesystem configurations, and the like.

Methods for Managing Subtrees

Subtree Decomposition

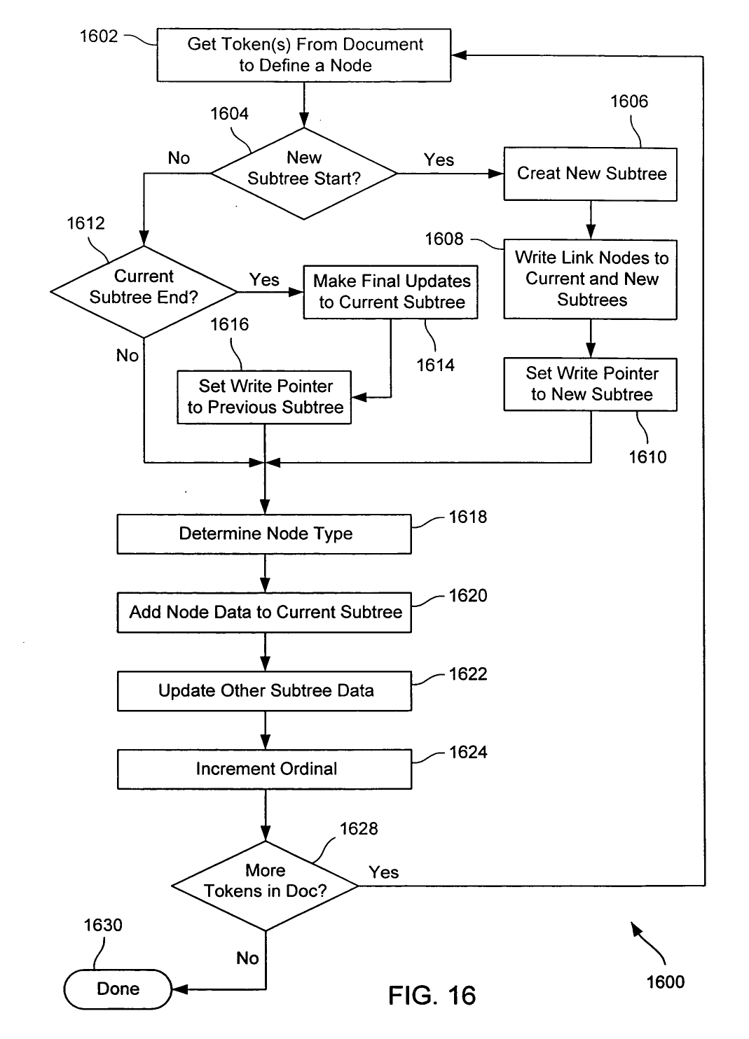

FIG. 16 is a flow diagram of a process 1600 for decomposing a structured document into subtrees according to an embodiment of the present invention. Process 1600 includes identifying a node, selecting (or creating) a subtree in a scratch area (e.g., scratch storage 1320 of FIG. 13) for writing the node, and writing the node to the appropriate subtree. The document can be traversed from beginning to end, with subtrees being created as the document is traversed.

More specifically, to select a subtree, at step 1602, a token or sequence of tokens is read from the document, e.g., by XML parser 1316, until enough information is available to define a node (e.g., for an element node, the tag name and its angle-bracket delimiters might be grouped together as a node-defining group of tokens). At step 1604, it is determined whether a new subtree is required for this token or group of tokens; e.g., stand builder 1318 might determine whether the node contains an element label that matches a subtree root label (e.g., ‘<c>’ for the document of FIG. 7) specified in parameter storage 1312. If so, then at step 1606, a new subtree is created in scratch storage unit 1320. At step 1608, a link node to the new subtree is added to the current subtree, and a link node to the current subtree is added to the new subtree. At step 1610, a write pointer is modified to reference the new subtree, which becomes the current subtree. The previous value of the write pointer may be pushed onto a stack so that it can be retrieved when the new subtree is finished.

If a new subtree was not required at step 1604, then at step 1612 it is determined whether the current token or group of tokens indicates that a current subtree is ending (e.g., whether the tag ‘</c>’ for the document of FIG. 7 has occurred). If so, then at step 1614 any final updates to the current subtree data structure are made, and at step 1616, the write pointer is restored to the previous subtree (e.g., popped off the stack).

Having selected the proper subtree, data for a new node is added to the subtree. For instance, at step 1618, the node type (e.g., element, attribute, text) is determined based on the node being processed. At step 1620, the appropriate node data is added to the current subtree (as determined from the write pointer). At 1622, other subtree data (e.g., node count) is updated to reflect the new node. At step 1624, an ordinal counter is incremented. This ordinal counter provides a value that is written into the subtree data structure for each new subtree; note that process 1600 comes nodes rather than subtrees, so that the ordinals for a subtree provide a map reflecting the organization of the input document. At step 1628, it is determined whether the document contains additional tokens. If so, the process returns to step 1602 to continue traversing the document. Otherwise, the process exits at step 1630. At step 1630, final updates may be made to the top-level subtree data structure, and other activity may occur, such as updating an activity log (or journal record) to reflect that the document has been processed.

It will be appreciated that process 1600 is illustrative and that variations and modifications are possible. Order of steps may be varied, steps shown as sequential may be executed in parallel, or processing steps may be combined or omitted. Any of the data writing steps may include encoding data prior to writing it, and/or modifying or relocating any previously written data for a subtree as needed to accommodate the new information. Other schemes for traversing a document might also be implemented, including schemes that use search techniques to identify subtrees within the document.

In some instances, adding data to a subtree may cause an in-scratch stand 1321 to reach its size limit (defined, e.g., by the maximum capacity of scratch storage unit 1320). In that case, the in-scratch stand is flushed (e.g., subtrees are moved to disk); any incomplete subtrees might remain in scratch storage unit 1320 to be completed after completed subtrees have been removed from the scratch storage unit. Flushing an in-scratch stand to disk might include converting the data structures to files (e.g., as described above with reference to FIG. 15), adding additional information to the data structures, and generating auxiliary files or data structures such as TreeIndex file 1512, Ordinals file 1522, URI-Keys file 1524, and Unique-Keys file 1526. Timestamps file 1520 might also be created when a stand is flushed and initialized to store the current time as the creation timestamp for each subtree, with all deletion timestamps initialized to zero or another value indicating that the subtrees are current. Alternatively, timestamps could be established as each subtree is created (e.g., during step 1606).

Updating Subtrees in On-Disk Stands

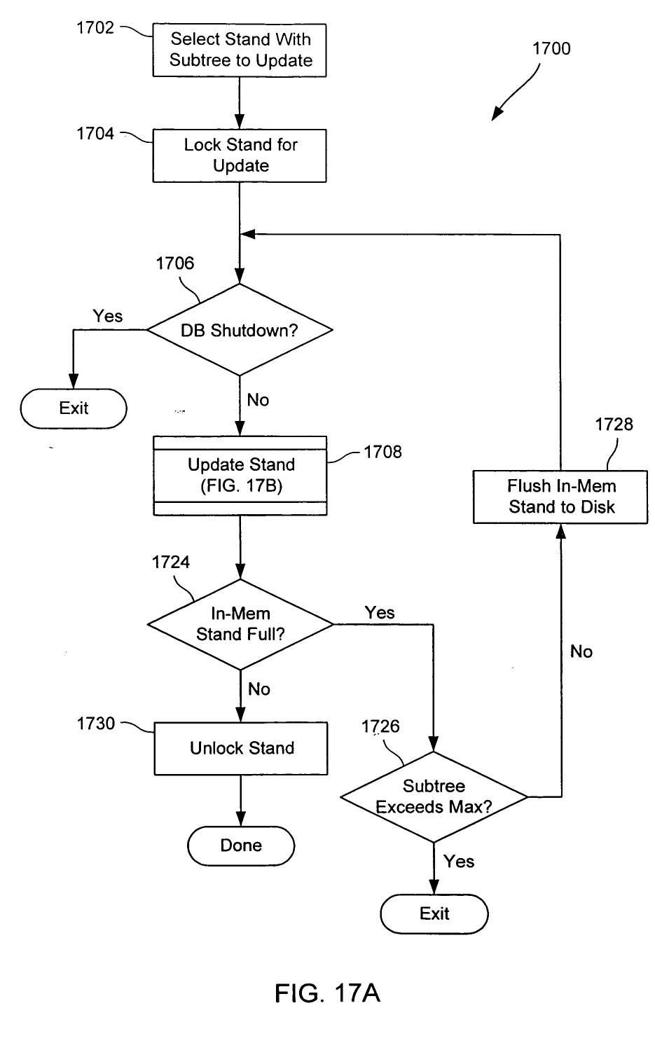

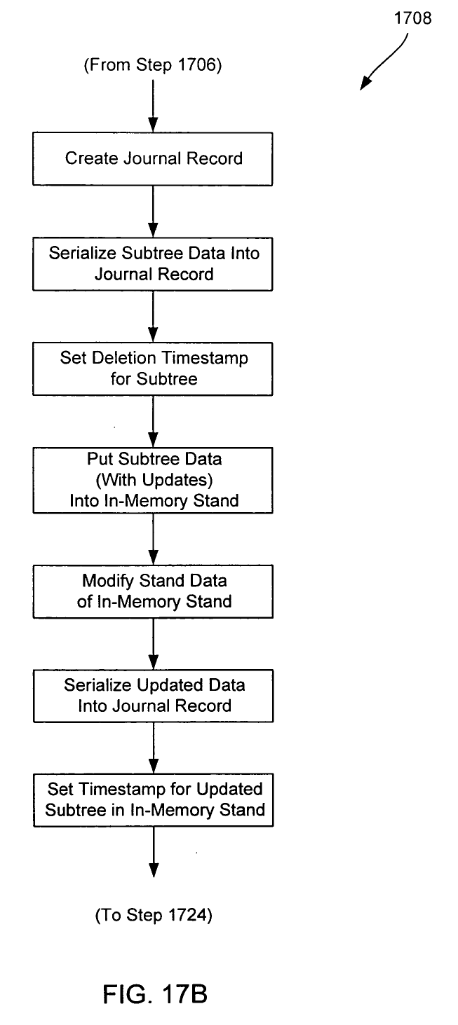

After a subtree has been created and flushed to disk, it may be desirable to update the subtree. For instance, the data content of a node could change, nodes could be added or deleted, or relationships between nodes could be altered (e.g., a child node could be promoted to a sibling, or sibling nodes could be reconfigured as parent and child). FIGS. 17A-B are flow diagrams of a process 1700 for updating a subtree in an on-disk stand according to an embodiment of the present invention. The process, which may be performed, e.g., by database manager 1332 of FIG. 13, involves moving the subtree into a memory cache where it can be updated. At step 1702, a stand with a subtree to be updated is selected. At step 1704, the stand is locked to avoid conflicts while data therein is in the process of being updated. At step 1706, it is determined whether a database shutdown is in progress; if so, the process exits without updating the subtree. Otherwise, at step 1708, the subtree update is performed.

Step 1708 is illustrated in detail in FIG. 17B. At step 1710, a journal record is created. At step 1712, the subtree data for the stand is serialized into the journal record. The journal record, which might record every event that changes the state of a stand (including, e.g., loading and deletion of documents, as well as insertion, updating, or deleting of elements in a subtree within the stand), can be used to reconstruct the state of the database in the event of a failure that causes damage to a stand (e.g., operating system failure during an update). At step 1714, the subtree is marked as deleted (e.g., by setting a deletion timestamp in Timestamps file 1520 of FIG. 15 to reflect the current time).

At step 1715, the subtree data is copied into an in-memory stand and updated. The in-memory stand consists of stand data (which may include various components of the stand data described above with reference to FIG. 15) stored in a memory cache of suitable size. In some instances, scratch storage 1320 of FIG. 13 might be used as the memory cache, or a different memory cache might be used. Like in-scratch stand 1321 of FIG. 13, subtrees in the in-memory stand can be freely modified; e.g., new subtrees can be added and data structures in existing subtrees can be altered. Unlike the in-scratch stand 1321, the in-memory stand is associated with a forest in database 1308, and queries over the database might also process the in-memory stand.

At step 1716, the in-memory stand data is updated for consistency with the new subtree. As described above with reference to FIG. 11, as long as subtrees are not created or destroyed, only the subtree data structure where changes occur is usually affected. Some updates (e.g., deletion of nodes) will affect other subtrees as well, and step 1716 might include triggering additional operations to update related subtrees. When the updates are done (or as updates are being done), various auxiliary data for the stand is also updated as appropriate.

At step 1718, the updated subtree data from the in-memory stand is serialized into a journal record, which may be the same journal record used at step 1712 or a different record. At step 1720, the timestamps for the subtree(s) affected by the updates are modified to reflect the current time.

Returning to FIG. 17A, at step 1724 it is determined whether the in-memory stand is full. If so, then a check is performed at step 1726 to verify that no subtree exceeds a maximum allowable size (e.g., the maximum stand size). If the subtree is too large, process 1700 exits with an error. Otherwise, the in-memory stand is flushed to disk at step 1728; this may be generally similar to flushing an in-scratch stand to disk as described above. The subtree that was to be updated is then processed again in a new in-memory stand.

At step 1730, in the event that the update was successful, the old stand (from which the subtree was deleted at step 1714) is unlocked and process 1700 ends.

It will be appreciated that process 1700 is illustrative and that variations and modifications are possible. Order of steps may be varied, steps shown as sequential may be executed in parallel, or processing steps may be combined or omitted. Further details related to updating subtrees and maintaining consistency while subtrees are being updated are described in Lindblad IIIA.

It should be noted that process 1700 might have the effect of moving a subtree from one stand to another within a forest. In some embodiments, this does not affect subtree link nodes that might be stored in various other subtrees because the link nodes store a subtree identifier that is unique within the forest, enabling the appropriate target subtree to be located regardless of which stand it is in. A data structure might be provided for a forest or stand that includes information about which stand a subtree identifier corresponds to. This information would be updated as subtrees move from stand to stand.

Embodiments of the present invention provide an XML database with a subtree structure. When XML data is modified, only a small number of subtrees typically need to be revised. Each subtree includes link information that facilitates reconstruction of the hierarchical relationships among subtrees In addition, the subtree data structure can be made self-contained, allowing subtrees to be portable. Data compression can also be provided, e.g., by using atoms to represent text data, as well as by applying additional compression techniques when data is written to disk and decompression techniques when data from disk is read into memory to be processed. Queries may be processed efficiently by applying the query to groups of subtrees (i.e., stands) and aggregating the results.

While the invention has been described with respect to specific embodiments, one skilled in the art will recognize that numerous modifications are possible. The data structures described herein can be modified or varied; particular data contents and coding schemes described herein are illustrative and not limiting of the invention. Any or all of the data structures described herein (e.g., forests, stands, subtrees, atoms) can be implemented as objects using CORBA or object-oriented programming. Such objects might contain both data structures and methods for interacting with the data. Different object classes (or data structures) may be provided for in-scratch, in-memory, and/or on-disk objects. References to memory or disk are to be understood as encompassing appropriate alternative storage structure.

Additional features to support portability across different machines or different file system implementation, random access to large files, concurrent access to a file by multiple processes or threads, various techniques for encoding/decoding of data, and the like can also be implemented. Persons of ordinary skill in the art with access to the teachings of the present invention will recognize various ways of implementing such options.

Various features of the present invention may be implemented in software running on one or more general-purpose processors in various computer systems, dedicated special-purpose hardware components, and/or any combination thereof. Computer programs incorporating features of the present invention may be encoded on various computer readable media for storage and/or transmission; suitable media include suitable media include magnetic disk or tape, optical storage media such as compact disk (CD) or DVD (digital versatile disk), flash memory, and carrier signals adapted for transmission via wired, optical, and/or wireless networks including the Internet. Computer readable media encoded with the program code may be packaged with a device or provided separately from other devices (e.g., via Internet download).

Thus, although the invention has been described with respect to specific embodiments, it will be appreciated that the invention is intended to cover all modifications and equivalents within the scope of the following claims.

What is claimed is:

1. A method for handling structured data, the method comprising:
(a) parsing the structured data into a plurality of related nodes;
(b) detecting a subtree root node in the plurality of related nodes, the subtree root node identifying a division point between an upper subtree and a lower subtree, each of the upper subtree and the lower subtree including at least one node and the lower subtree including the subtree root node;
(c) identifying, in the upper subtree, a parent node of the subtree root node; and
(d) creating a first link node for the upper subtree and a second link node for the lower subtree, wherein the first link node includes a reference to the lower subtree and the second link node includes a reference to the upper subtree.

2. The method of claim 1, further comprising:
(e) navigating from the first link node to the second link node by:
(i) using the reference of the first link node to locate the lower subtree;
(ii) accessing the lower subtree; and
(iii) within the lower subtree, identifying the second link node by locating a node that includes a reference to the upper subtree.

3. The method of claim 1, further comprising:
(f) navigating from the second link node to the first link node by:
(i) using the reference of the second link node to locate the upper subtree;
(ii) accessing the upper subtree; and
(iii) within the upper subtree, identifying the first link node by locating a node that includes a reference to the lower subtree.

4. The method of claim 1, wherein the structured data comprises an XML document.

5. The method of claim 1, wherein detecting a subtree root node includes detecting a node that contains an element label that matches a preselected root label.

6. The method of claim 1, further comprising:
(e) storing a first subtree data structure for the upper subtree, the first subtree data structure including the first link node; and
(f) storing a second subtree data structure for the lower subtree, the first subtree data structure including the second link node.

7. The method of claim 6, further comprising:
(g) defining a stand containing a plurality of subtrees, wherein the plurality of structures includes at least one of the lower subtree and the upper subtree.

8. The method of claim 7, further comprising:
(h) defining a forest containing a plurality of stands.

9. The method of claim 1, wherein detecting a subtree root node includes determining whether a size criterion is satisfied.

10. A system for handling structured data, the system comprising:
a parser configured to receive the structured data and to decompose the structured data into a plurality of subtrees including at least an upper subtree and a lower subtree, wherein the upper subtree and the lower subtree are connected at a subtree root node;
a builder module configured to generate a subtree data structure for each of the plurality of subtrees, including a first subtree data structure corresponding to the upper subtree and a second subtree data structure corresponding to the lower subtree; and
a storage space configured to store the subtree data structures generated by the builder module,
wherein the first subtree data structure includes a first link node that contains a reference to the second subtree data structure and the second subtree data structure includes a second link node that contains a reference to the first subtree data structure.

11. The system of claim 10, wherein the second subtree data structure further includes a node corresponding to the subtree root node.

12. The system of claim 10, wherein the structured data comprises an XML document.

13. The system of claim 10, wherein the subtree root node contains an element label that matches a preselected root label.

14. The system of claim 10, further comprising a stand module configured to construct at least one stand, each stand containing a plurality of subtree data structures.

15. The system of claim 14, further comprising a query module configured to access the at least one stand.

16. The system of claim 14, further comprising an update module configured to update one of the subtree data structures contained in one of the at least one stand by marking the subtree data structure in the stand as deleted and re-creating the subtree data structure with updated data as a subtree data structure in a new stand.

17. The system of claim 14, wherein at least two stands are constructed, the system further comprising a merge module configured to select at least two of the stands and to merge the selected stands into a new stand.
